(19) United States
(12) Patent Application Publication
(10) Pub. No.: US 2018/0018807 A1
(43) Pub. Date: Jan. 18, 2018

(54) METHOD AND APPARATUS FOR GENERATING PANORAMIC IMAGE WITH TEXTURE MAPPING

(71) Applicant: ASPEED Technology Inc., Hsinchu City (TW)

(72) Inventors: Chung-Yen LU, Hsinchu City (TW); Pei-Hen HUNG, Hsinchu City (TW); HUNG-JU HUANG, Hsinchu City (TW); HUNG-MING LIN, Hsinchu City (TW)

(21) Appl. No.: 15/211,732

(22) Filed: Jul. 15, 2016

(51) Int. Cl. G06T 15/04; H04N 5/232

(52) U.S. Cl. CPC G06T 15/04; H04N 5/23238

(57) ABSTRACT

An image processing apparatus is disclosed, which comprises a rasterization engine, a texture mapping module and a destination buffer. The rasterization engine receives a group of vertices from a vertex list and performs polygon rasterization operations for a point within the group of vertices forming a polygon to generate texture coordinates for each camera image. The vertex list comprises a plurality of vertices with their data structures. The texture mapping module texture maps texture data from each camera image according to its texture coordinates to generate a sample value for each camera image. The destination buffer is coupled to the texture mapping module and stores the panoramic image. Here, the data structures define a mapping between the panoramic image and the camera images.

### BACKGROUND OF THE INVENTION

### Field of the Invention

The invention relates to panoramic imaging, and more particularly, to a method and apparatus for generating panoramic images with texture mapping.

### Description of the Related Art

360 degree panoramic images, also known as 360 panoramic images, full panoramic images, or spherical images, are video recordings of a real-world panorama, where the view in every direction is recorded at the same time, shot using an omnidirectional camera or a collection of cameras. A 360 degree panoramic image covers 360 degree field of view (FOV) horizontally and 180 degree vertically.

An equirectangular video is a commonly projection used in 360 video. A common example of equirectangular projection is a standard world map, which maps the surface of the world (a sphere) onto orthogonal coordinates. That is, equirectangular projection maps the latitude and longitude coordinates of a spherical globe directly onto horizontal and vertical coordinates of a grid. Image distortion is minimal at the equator, and infinite at the poles. The poles (Zenith, Nadir) are located at the top and bottom edge and are stretched to the entire width of the image. What is needed is a method to render areas near poles correctly and precisely. Due to the large stretch of areas near poles, rendering images for these areas seems kind of wasteful. What is further needed is a method to reduce the redundancy for areas near poles.

### SUMMARY OF THE INVENTION

In view of the above-mentioned problems, an object of the invention is to provide an image processing apparatus capable of correctly and precisely rendering panoramic images for the pole regions with minimum redundancy.

One embodiment of the invention provides an image processing apparatus that receives a plurality of camera images and generates a panoramic image. The image processing apparatus comprises a rasterization engine, a texture mapping module and a destination buffer. The rasterization engine receives a group of vertices from a vertex list and performs polygon rasterization operations for a point within the group of vertices forming a polygon to generate texture coordinates for each camera image. The vertex list comprises a plurality of vertices with their data structures. The texture mapping module texture maps texture data from each camera image according to its texture coordinates to generate a sample value for each camera image. The destination buffer is coupled to the texture mapping module and stores the panoramic image. Here, the data structures define a vertex mapping between the panoramic image and the camera images.

Another embodiment of the invention provides an image processing method applied in an image processing apparatus. The method comprises: receiving a group of vertices from a vertex list; performing polygon rasterization operations for a point within the group of vertices forming a polygon to obtain texture coordinates for each of a plurality of camera images, wherein the vertex list comprises a plurality of vertices with their data structures; texture mapping texture data from each camera image according to its texture coordinates to obtain a sample value for each camera image corresponding to the point; and, repeating the above steps until all the points within the polygon are processed; wherein the data structures define a vertex mapping between the panoramic image and the camera images.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing a panoramic image processing system of the invention.

FIG. 2 shows a relation between a cube framework and a sphere.

FIG. 3 shows an equirectangular panoramic image derived from an equirectangular projection of six-face camera images (top, bottom, right, left, front, back).

FIG. 4A shows a pole triangle PQN on the sphere surface.

FIG. 4B shows a quadrilateral PQN₁N₂ by performing an equirectangular projection of the pole triangle PQN of FIG. 4A.

FIG. 5A shows a triangle mesh modeling a sphere surface.

FIG. 5B shows a polygon mesh composing the default equirectangular panoramic image.

FIG. 6A is a schematic diagram showing the image processing apparatus according to one embodiment of the invention.

FIG. 6B is a schematic diagram showing the image processing apparatus according to another embodiment of the invention.

FIG. 6C is a schematic diagram showing the image processing apparatus according to another embodiment of the invention.

FIG. 6D is a schematic diagram showing the image processing apparatus according to another embodiment of the invention.

FIG. 7A shows a flow chart of an image processing method according to another embodiment of the invention.

FIGS. 7B and 7C show a flow chart of an image processing method according to another embodiment of the invention.

FIG. 8 shows a relationship between a modified equirectangular panoramic image and a default/reconstructed equirectangular panoramic image.

FIG. 9 shows an exemplary geometry of a modified equirectangular panoramic image.

FIG. 10 shows an example of a modified equirectangular panoramic image with a closed curve.

### DETAILED DESCRIPTION OF THE INVENTION

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context. The term “pole triangle” refers to a triangle with a vertex being a pole point (Zenith, Nadir) in a triangle mesh modeling a sphere surface. The term “rasterization” refers to a process of computing the mapping from scene geometry (or a panoramic image) to texture coordinates.

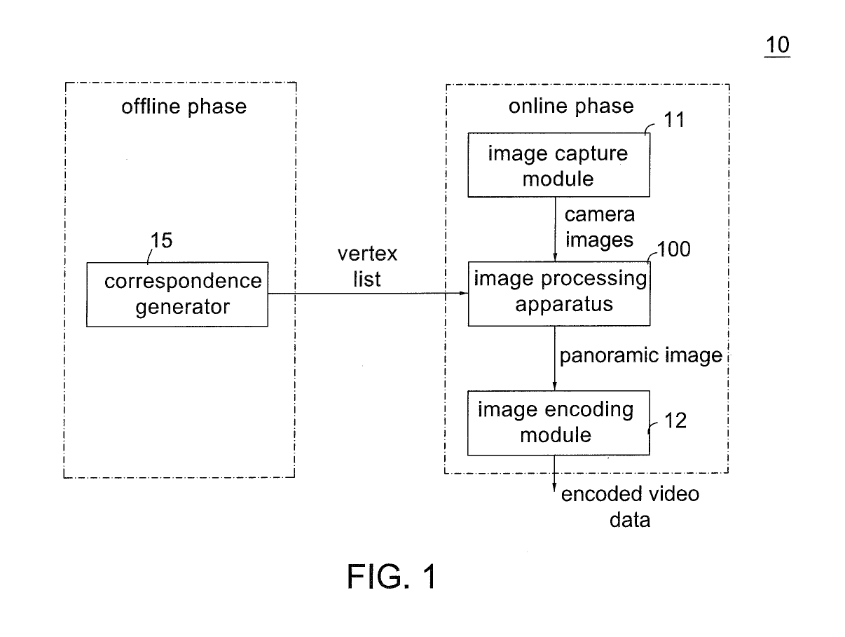

FIG. 1 is a diagram showing a panoramic image processing system of the invention. Referring to FIG. 1, the panoramic image processing system 10 includes an image capture module 11, an image processing apparatus 100, an image encoding module 12 and a correspondence generator 15. The image capture module 11 is capable of capturing a view with 360 degree horizontal FOV and 180 degree vertical FOV to generate a plurality of camera images. After receiving the camera images from the image capture module 11, the image processing apparatus 100 performs rasterization, texture mapping and blending operations to form a panoramic image according to a vertex list (will be described later). Finally, the encode module 12 encodes the panoramic image and transmits the encoded video data.

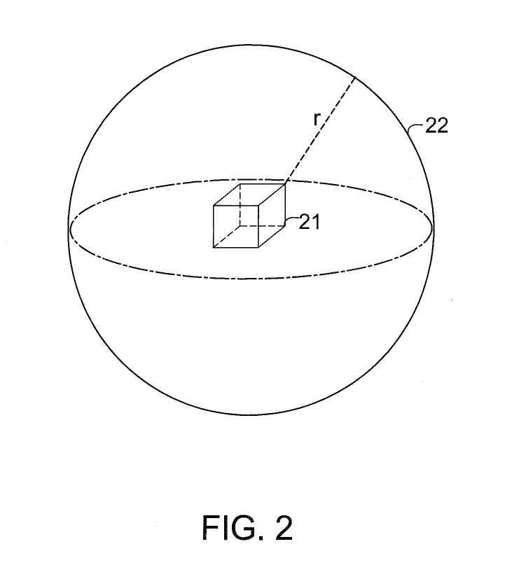

In one embodiment, to capture a view with 360-degree horizontal FOV and 180-degree vertical FOV, the image capture module 11 includes a plurality of cameras. The cameras are properly placed so as to cover the system FOV up to 360 degree horizontally and 180 degree vertically. For example, as shown in FIG. 2, the image capture module 11 includes six cameras (not shown) respectively mounted on the six faces of a cube framework 21 to simultaneously capture a view of the world with 360-degree horizontal FOV and 180-degree vertical FOV to generate six camera images. In an alternative embodiment, the image capture module 11 includes two fish-eye lens (not shown). A requirement is that there should be sufficient overlaps between the views of two adjacent cameras/lenses to facilitate the image mosaicking. Please note that the number of the cameras/fish-eye lenses is not limited as long as they are able to capture a FOV up to 360 degree horizontally and 180 degree vertically. Please also note that for ease of calibration, relative positions and orientations among the cameras/lenses are fixed during image capture. Examples of the panoramic image include, without limitation, a 360 degree panoramic image and an equirectangular panoramic image.

For purposes of clarity and ease of description, hereinafter, the following examples and embodiments will be described with the equirectangular panoramic image and with the assumption that the image capture module 11 includes the six cameras respectively mounted on the six faces of the cube framework 21.

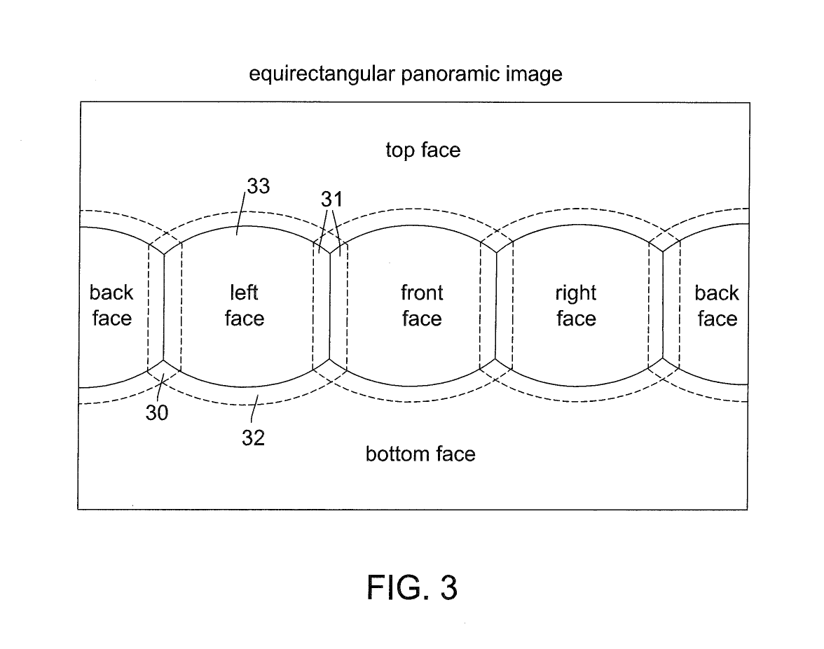

In order to store and display conveniently on computer screens, a spherical projection is mapped to an equirectangular panoramic image. Its aspect ratio is chosen to be 2:1, with the horizontal coordinate representing the azimuth angle θ∈0°˜360°, and the vertical coordinate representing the elevation angle φ∈−90°˜90+. FIG. 3 shows an equirectangular panoramic image derived from an equirectangular projection of the six camera images from the six cameras of the image capture module 11. Referring to FIG. 3, pixels in regions 30 are overlapping by three camera images and pixels in regions 31-32 are overlapping by two camera images while pixels in regions 33 comes from a single camera image. The image processing apparatus 100 need to perform blending operations over the overlapping regions for stitching the six camera images.

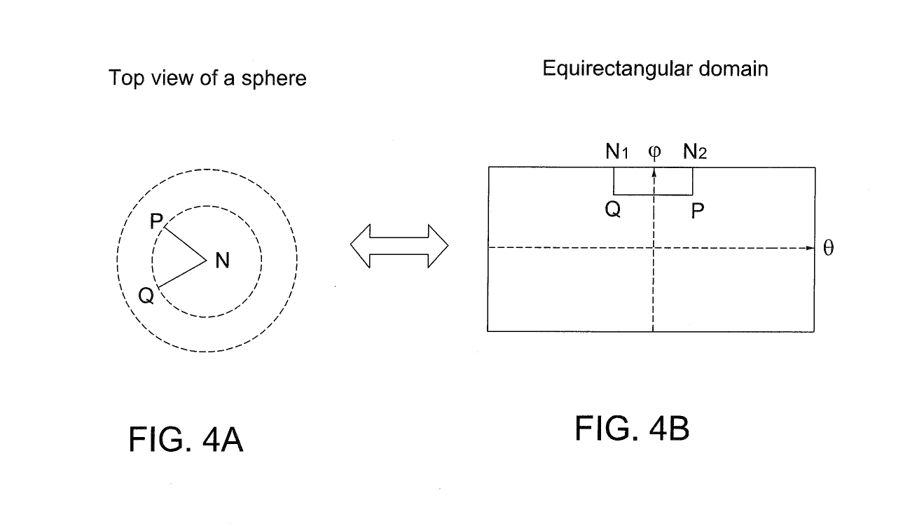

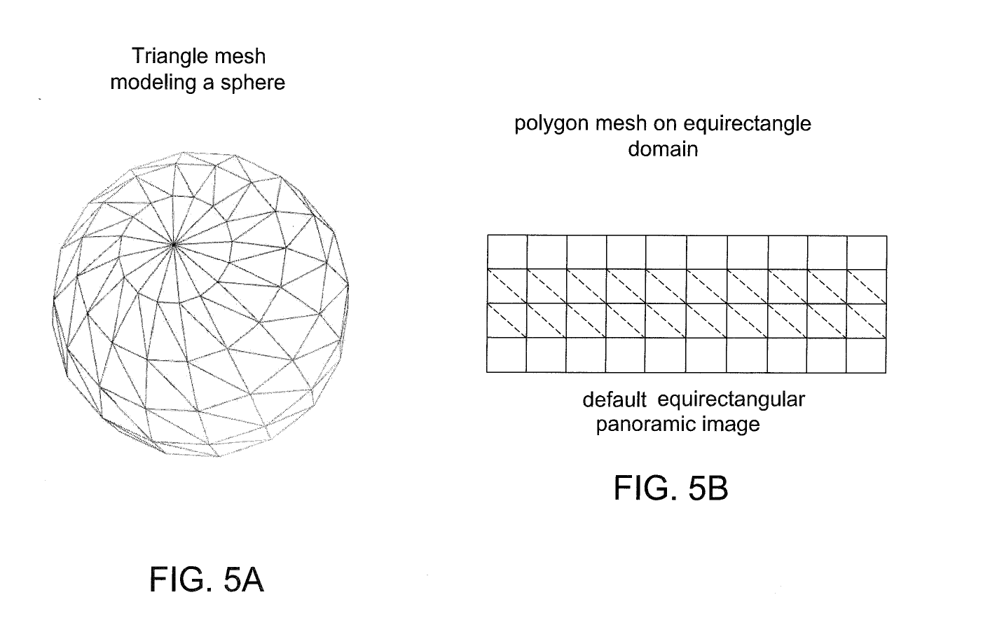

FIG. 5A shows a triangle mesh modeling a sphere surface. The surface of the sphere 22 is modeled by using a triangle mesh as shown in FIG. 5A. Assuming that there is a pole triangle PQN on the sphere surface in FIG. 4A and its vertex N is a pole point. When the pole triangle PQN on the sphere surface in FIG. 4A is projected to the 2D equirectangular domain, the pole triangle PQN becomes a quadrilateral PQN₁N₂ in FIG. 4B. Specifically, after an equirectangular projection is performed, vertices P and Q respectively have equirectangular coordinates (θ_{P}, φ_{P}) and (θ_{Q}, φ_{Q}), and the pole point N is regarded as two points N₁ and N₂ with equirectangular coordinates (θ_{P}, φ_{N}) and (θ_{Q}, φ_{N}), respectively, where φ_{P}=φ_{Q}. FIG. 5B shows a polygon mesh composing/modeling the equirectangular panoramic image. The polygon mesh of FIG. 5B is produced by performing an equirectangular projection of the triangle mesh of FIG. 5A. The polygon mesh in FIG. 5B is a collection of quadrilaterals/triangles. Please note that only the top row and the bottom row of the polygon mesh in FIG. 5B are formed by quadrilaterals because they are projected from the pole triangles of the triangle mesh in FIG. 5A. Accordingly, the image processing apparatus 100 performs quadrilateral rasterization operations for each point/pixel of the quadrilaterals in the top row and the bottom row of the polygon mesh, and selectively performs triangle or quadrilateral rasterization operations for each point/pixel of the triangles or the quadrilaterals in the other rows of the polygon mesh.

FIG. 1 also shows the processing pipeline of the panoramic image processing system 10. The processing pipeline is divided into an offline phase and an online phase. In the offline phase, the six cameras are calibrated separately. The correspondence generator 15 adopts appropriate image registration techniques to generate a vertex list, and each vertex in the vertex list provides the mapping between the equirectangular panoramic image and camera images (or between the equirectangular coordinates and the texture coordinates). For example, the sphere 22 with 2 meter radius (r=2) is drawn in many circles as latitude and longitude, whose intersection points are treated as calibration points. The six cameras capture these calibration points, and their positions on camera images are known. Then the mapping relationship between the equirectangular panoramic image and camera images are constructed since the view angles of the calibration points and camera coordinates are linked. A calibration point with the mapping relationship is defined as a “vertex” in this invention. The correspondence generator 15 completes all necessary computations in the offline phase.

According to the geometry of the equirectangular panoramic image and camera images, the correspondence generator 15 computes equirectangular coordinates and texture coordinates for each vertex in the polygon mesh and determines whether the vertex is a pole point to generate the vertex list. Finally, the correspondence generator 15 supplies the vertex list to the image processing apparatus 100. Once the vertex list is generated, it is repeated used by the image processing apparatus 100 for stitching subsequent camera images.

In the online phase, minimal work is conducted to create the the equirectangular panoramic image. According to the vertex list, the image processing apparatus 100 simply regards the subsequent camera images from the image capture module 11 as textures, maps them onto the polygon mesh and stitches them together to form the equirectangular panoramic image in real time.

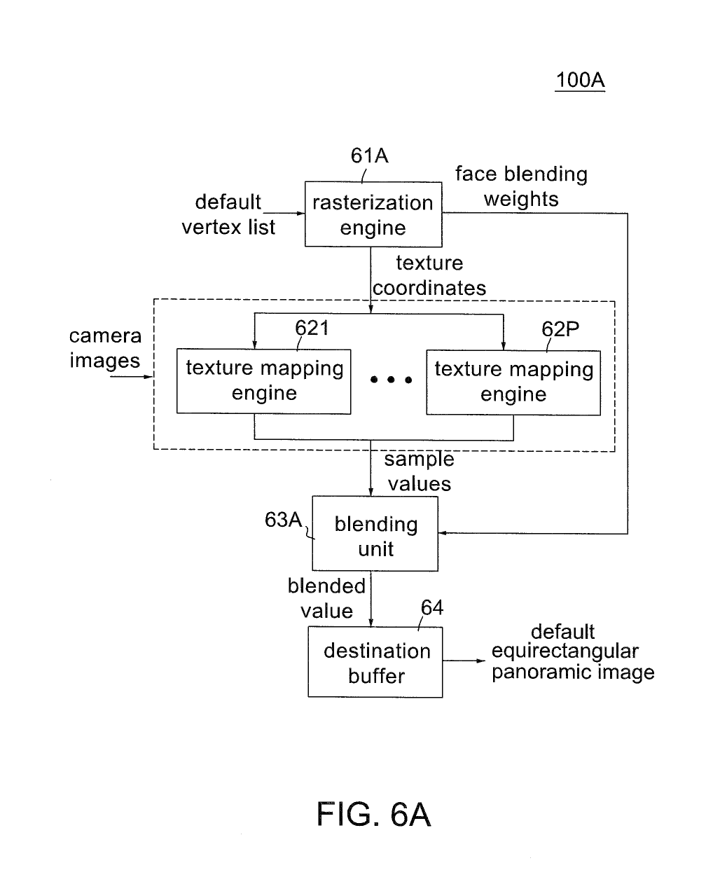

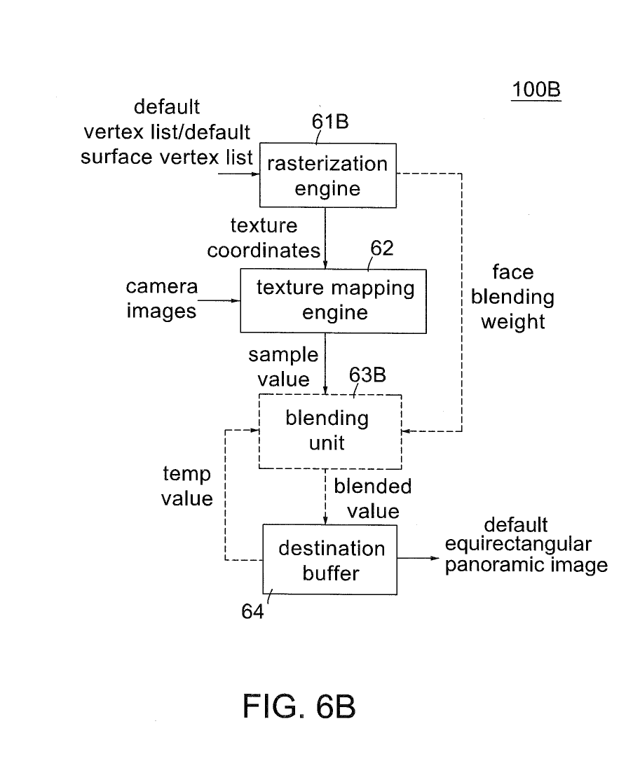

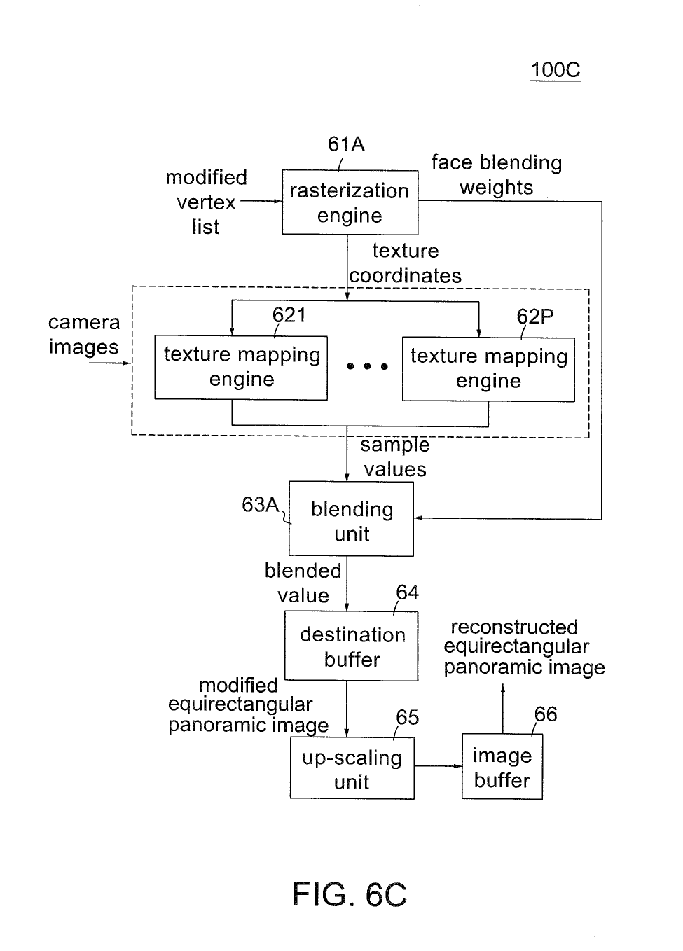

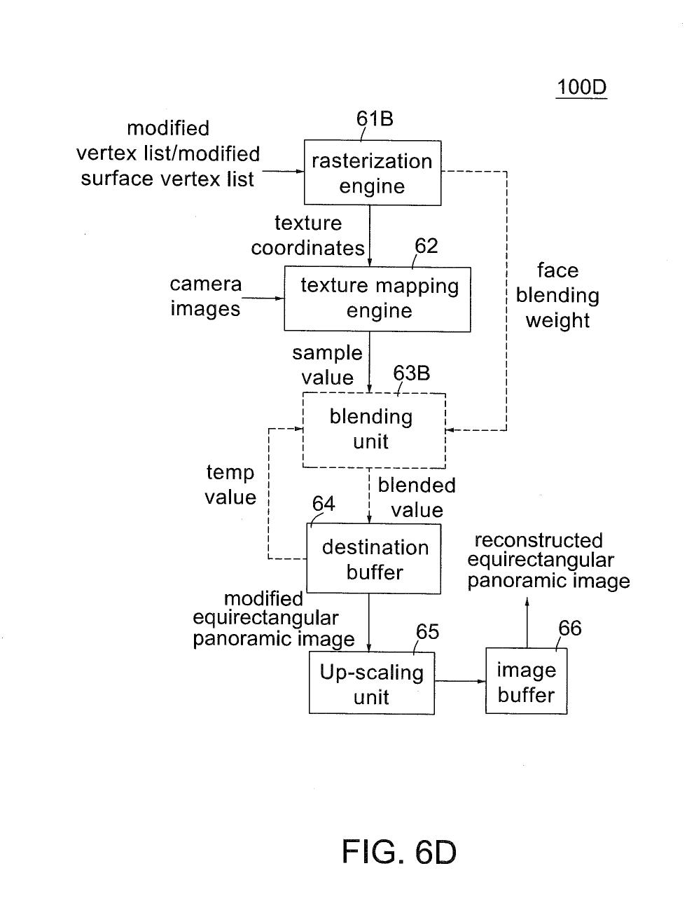

FIG. 6A is a schematic diagram showing the image processing apparatus according to one embodiment of the invention. In this embodiment, and subsequent embodiments, common reference numerals have been employed where common circuit elements have the same function as in other embodiments described herein.

Referring to FIG. 6A, the image processing apparatus 100A includes a rasterization engine 61A, P texture mapping engines 621˜62P (P>=2), a blending unit 63 and a destination buffer 64. The P texture mapping engines 621˜62P operate in parallel. At first, the rasterization engine (61A, 61B) receives the vertex list from the correspondence generator 15 and retrieves a group of vertices forming a polygon from the vertex list at a time. In one embodiment, the rasterization engine (61A, 61B) retrieves four vertices forming a quadrilateral from the vertex list at a time. Then, the rasterization engine 61A performs triangle/quadrilateral rasterization operations for each point/pixel in the triangles/quadrilaterals of the polygon mesh of FIG. 5B. In practice, there are two modes for the rasterization engine (61A, 61B): a quadrilateral mode and a hybrid mode. In quadrilateral mode, the rasterization engine (61A, 61B) simply performs quadrilateral rasterization operations only for each point/pixel in all the quadrilaterals of the polygon mesh to generate texture coordinates and face blending weights for each camera image. In hybrid mode, the rasterization engine (61A, 61B) determines whether to divide a current quadrilateral into two triangles according to whether any of the four vertices is a pole point and performs triangle/quadrilateral rasterization operations for each point/pixel in the triangles/quadrilaterals of the polygon mesh to generate texture coordinates and face blending weights for each camera image. In one embodiment, In hybrid mode, for a quadrilateral in the top row or the bottom row of the polygon mesh, the rasterization engine (61A, 61B) directly performs quadrilateral rasterization operations for each point of the quadrilateral; for a quadrilateral in the other rows of the polygon mesh, the rasterization engine (61A, 61B) first divides the quadrilateral into two triangles and then performs triangle rasterization operations for each point of each triangle. The vertex list is a list of a plurality of vertices forming a plurality of quadrilaterals of the polygon mesh and each vertex is defined by its corresponding data structure. The data structure defines a vertex mapping between a destination space and a texture space (or between the equirectangular coordinates and the texture coordinates). In one embodiment, the data structure includes, without limitation, equirectangular coordinates, a pole flag, the number of covering/overlapping camera images, texture coordinates in each camera image, ID for each camera image and a blending weight for each camera image.

Table 1 shows an exemplary data structure of for each vertex in the vertex list.

TABLE 1

| Attributes | Descriptions |
|---|---|
| (x, y) | Equirectangular coordinates |
| Pole flag | Indicate whether the vertex is a pole point(e.g., 1: pole |
| | point; 0: not pole point) |
| N | Number of covering/overlapping camera images |
| ID₁ | ID of first camera image |
| (u₁, v₁) | Texture coordinates in first camera image |
| w₁ | Default blending weight for first camera image |
| . . . | . . . |
| ID_{N} | ID of N^{th} camera image |
| (u_{N}, V_{N}) | Texture coordinates in N^{th} camera image |
| w_{N} | Default blending weight for N^{th} camera image |

In the above embodiment, the “”pole flag” field is filled/calculated by the correspondence generator 15. In an alternative embodiment, the “”pole flag” field is filled/determined by the rasterization engine (61A, 61B) according to equirectangular coordinate (x, y) of each vertex. For example, when y=0 (Nadir) or y=Hp (Zenith), the rasterization engine (61A, 61B) sets the “pole flag” field to 1, otherwise, sets the “pole flag” field to 0.

As shown in FIG. 3, since the image capture module 11 includes the six cameras, the number N of camera images that cover one vertex or overlap at one vertex is less than or equal to three, i.e., 1<=N<=2. Please note that the six cameras included in the image capture module 11 and the at most three camera images that cover one vertex or overlap at one vertex are provided by example and not limitations of the invention. In practice, the number N of camera images that cover one vertex or overlap at one vertex is varied according to different numbers of cameras included in the image capture module 11. Here, P is the maximum of the N values for all vertices in the vertex list.

Assuming that P=3, each of four vertices (A, B, C, D) of one quadrilateral of the polygon mesh is overlapped with three-face camera images (front, top, right; N=3), and the four vertices (A, B, C, D) have the following data structures contained in the vertex list: vertex A:{(x_{A}, y_{A}), 0, 3, ID_{Front}, (u_{1A}, v_{1A}), w_{1A}, ID_{Top}, (u_{2A}, v_{2A}), w_{2A}, ID_{Right}, (u_{3A}, v_{3A}), w_{3A}}; vertex B:{(x_{B}, y_{B}), 0, 3, ID_{Front}, (u_{1B}, v_{1B}), w_{1B}, ID_{Top}, (u_{2B}, v_{2B}), w_{2B}, ID_{Right}, (u_{3B}, v_{3B}), w_{3B}}; vertex C:{(x_{C}, y_{C}), 1, 3, ID_{Front}, (u_{1C}, v_{1C}), w_{1C}, ID_{Top}, (u_{2C}, v_{2C}), w_{2C}, ID_{Right}, (u_{3C}, v_{3C}), w_{3C}}; vertex D:{(x_{D}, y_{D}), 1, 3, ID_{Front}, (u_{1D}, v_{1D}), w_{1D}, ID_{Top}, (u_{2D}, v_{2D}), w_{2D}, ID_{Right}, (u_{3D}, v_{3D}), w_{3D}}. The vertices C and D are derived from pole point(s).

The operations of the image processing apparatus 100A are described below based on the above four vertices (A, B, C, D). In hybrid mode that vertices C and D have pole flag equal to 1 (vertices C and D are derived from pole points) or in quadrilateral mode (don't care the pole flags), the rasterization engine 61A directly performs quadrilateral rasterization operations for the quadrilateral ABCD. Specifically, the rasterization engine 61A computes texture coordinates and a face blending weight for each camera image based on a point Q having equirectangular coordinates (x, y) within a quadrilateral ABCD of the polygon mesh by using the following steps: 1. Compute four spatial weighting values (a, b, c, d) according to equirectangular coordinates (x_{A}, y_{A}, x_{B}, y_{B}, x_{C}, y_{C}, x_{D}, y_{D}, x, y) by using a bi-linear interpolation method. 2. compute a face blending weight fw₁ for a sample point Q_{F} (corresponding to point Q) in front-face camera image: fw₁=a*w_{1A}+b*w_{1B}+c*w_{1C}+d*w_{1D}; compute a face blending weight fw₂ for a sample point Q_{T} (corresponding to point Q) in top-face camera image: fw₂=a*w_{2A}+b*w_{2B}+c*w_{2C}+d*w_{2D}; compute a face blending weight fw₃ for a sample point Q_{R} (corresponding to point Q) in right-face camera image: fw₃=a*w_{3A}+b*w_{3B}+c*w_{3C}+d*w_{3D}. 3. compute texture coordinates for the sample point Q_{F} (corresponding to point Q) in front-face camera image: (u1, v1)=(a*u_{1A}+b*u_{1B}+c*u_{1C}+d*u_{1D}, a*v_{1A}+b*v_{1B}+c*v_{1C}+d*v_{1D}); compute texture coordinates for the sample point Q_{T} (corresponding to point Q) in top-face camera image: (u2, v2)=(a*u_{2A}+b*u_{2B}+c*u_{2C}+d*u_{2D}, a*v_{2A}+b*v_{2B}+c*v_{2C}+d*v_{2D}); compute texture coordinates for a sample point Q_{R} (corresponding to point Q) in right-face camera image: (u3, v3)=(a*u_{3A}+b*u_{3B}+c*u_{3C}+d*u_{3D}, a*v_{3A}+b*v_{3B}+c*v_{3C}+d*v_{3D}). Finally, the rasterization engine 61A sends the three texture coordinates (u1, v1), (u2, v2) and (u3, v3) to the three texture mapping engines 621˜623 in parallel, and sends the face blending weights (fw₁, fw₂, fw₃) to the blending unit 63. Here, a+b+c+d=1 and fw₁+fw₂+fw₃=1.

According to the three texture coordinates (u1, v1), (u2, v2) and (u3, v3), the texture mapping engines 621˜623 texture map the texture data from the three-face camera images using any appropriate method (such as nearest-neighbour interpolation, bilinear interpolation or trilinear interpolation) to generate three sample values s1, s2 and s3, and then send the three sample values s1, s2 and s3 to the blending unit 63. Here, the sample value may be a luma value or/and a chroma value. The blending unit 63 blends the three sample values (s1, s2, s3) together to generate a blended value Vb of point Q. In one embodiment, after receiving the three face blending weights (fw₁, fw₂, fw₃) from the the rasterization engine 61A, the blending unit 63 blends the three sample values (s1, s2, s3) together to generate the blended value Vb of point Q using the following equation: Vb=fw₁*s1+fw₂*s2+fw₃*s3. Finally, the blending unit 63 stores the blended value Vb of point Q into the destination buffer 64. In this manner, the blending unit 63 sequentially stores the blended value Vb into the destination buffer 64 until all the points within the quadrilateral ABCD are processed/completed. Once all the quadrilaterals are processed, a default equirectangular panoramic image is completed.

FIG. 6B is a schematic diagram showing the image processing apparatus according to one embodiment of the invention. Referring to FIG. 6B, the image processing apparatus 100B includes a rasterization engine 61B, a texture mapping engine 62, a blending unit 63B and a destination buffer 64. As clearly shown in FIG. 6B, there is only one texture mapping engine 62 in this embodiment. For ease of description, the operations of the image processing apparatus 100B are described below based on the above same example (the point Q having equirectangular coordinates (x, y) within the quadrilateral ABCD of the polygon mesh).

The rasterization engine 61B sequentially sends the three texture coordinates (u1, v1), (u2, v2) and (u3, v3) to the texture mapping engine 62 and the three face blending weights (fw₁, fw₂, fw₃) to the blending unit 63B, i.e., sending one at a time after computing the three face blending weights (fw₁, fw₂, fw₃) and the three texture coordinates (u1, v1), (u2, v2) and (u3, v3). Then, the texture mapping engine 62 needs to perform the following operations three rounds, i.e., receiving the texture coordinates, texture mapping the texture data of one camera image to generate one sample value, and then sending its sample value to the blending unit 63B. Next, the blending unit 63B also computes and stores three rounds according to the three sample values (s1, s2, s3) and the three face blending weights (fw₁, fw₂, fw₃). Specifically, in the first round, the blending unit 63B receives the sample value s1 and the face blending weight fw₁, obtains a first temp value Vt1 by computing the equation: Vt1=fw₁*s1, and then stores the first temp value Vt1 in the destination buffer 64. In the second round, the blending unit 63B fetches the first temp value Vt1 from the destination buffer 64, receives the sample value s2 and the face blending weight fw₂, obtains a second temp value Vt2 by computing the equation: Vt2=Vt1+fw₂*s2, and then stores the second temp value Vt2 in the destination buffer 64. In the third round, the blending unit 63B fetches the first temp value Vt2 from the destination buffer 64, receives the sample value s3 and the face blending weight fw₃, obtains the blended value Vb by computing the equation: Vb=Vt2+fw₃*s3, and then stores the blended value Vb in the destination buffer 64. In this manner, the blending unit 63B sequentially stores the blended value Vb in the destination buffer 64 for each point/pixel until all the points within the quadrilateral ABCD are processed/completed. Once all the quadrilaterals are processed, the default equirectangular panoramic image is completed.

In an alternative embodiment, the vertex list is divided into six surface vertex lists respectively corresponding to six camera images. Each surface vertex list is a list of a plurality of vertices covered by a corresponding camera image and each vertex is defined by its corresponding data structure. The data structure defines a vertex mapping between a destination space and a texture space (or between the equirectangular coordinates and the texture coordinates of one camera image). In one embodiment, the data structure includes, without limitation, equirectangular coordinates, a pole flag, texture coordinates in the corresponding camera image, ID for the corresponding camera image and a blending weight for the corresponding camera image. Table 2 shows an exemplary data structure of for each vertex in each surface vertex list.

TABLE 2

| Attributes | Descriptions |
|---|---|
| (x, y) | Equirectangular coordinates |
| Pole flag | Indicate whether the vertex is a pole point(e.g., 1: pole |
| | point; 0: not pole point) |
| ID | ID of a corresponding camera image |
| (u, v) | Texture coordinates in first camera image |
| w | Default blending weight for the corresponding camera |
| | image |

In this embodiment, the six surface vertex lists are generated by the correspondence generator 15 and sequentially sent to the image processing apparatus 100B. After receiving a first one of the six surface vertex lists, the rasterization engine 61B, the texture mapping engine 62 and the blending unit 63B perform their operations (as mentioned above) over its corresponding camera image only. Since there are six surface vertex lists, the rasterization engine 61B, the texture mapping engine 62 and the blending unit 63B perform their operations over the six camera images six rounds.

The operations of the image processing apparatus 100A are further described below with the assumption that P=3, each of four vertices (A, B, C′, D′) of one quadrilateral of the polygon mesh is overlapped with three-face camera images (front, top, right; N=3), and the four vertices (A, B, C′, D′) have the following data structures contained in the vertex list: vertex A:{(x_{A}, y_{A}), 0, 3, ID_{Front}, (u_{1A}, v_{1A}), w_{1A}, ID_{Top}, (u_{2A}, v_{2A}), w_{2A}, ID_{Right}, (u_{3A}, v_{3A}), w_{3A}}; vertex B:{(x_{B}, y_{B}), 0, 3, ID_{Front}, (u_{1B}, v_{1B}), w_{1B}, ID_{Top}, (u_{2B}, v_{2B}), w_{2B}, ID_{Right}, (u_{3B}, v_{3B}), w_{3B}}, vertex C′:{(x_{C}, y_{C}), 0, 3, ID_{Front}, (u_{1C}, v_{1C}), w_{1C}, ID_{Top}, (u_{2C}, v_{2C}), w_{2C}, ID_{Right}, (u_{3C}, v_{3C}), w_{3C}}; vertex D′:{(x_{D}, y_{D}), 0, 3, ID_{Front}, (u_{1D}, v_{1D}), w_{1D}, ID_{Top}, (u_{2D}, v_{2D}), w_{2D}, ID_{Right}, (u_{3D}, v_{3D}), w_{3D}}. None of the vertices ABC′D′ is derived from a pole point.

In hybrid mode, after determining that none of the four vertices (A, B, C′, D′) has a pole flag equal to 1 (i.e., no vertex is derived from a pole point), the rasterization engine 61A first divides the quadrilateral ABC′D′ into two triangles (e.g., ABC′ and ABD′) and then performs triangle rasterization operations for each point of each triangle (ABC′ and ABD′). Specifically, the rasterization engine 61A computes texture coordinates and a face blending weight for each camera image based on a point Q′ having equirectangular coordinates (x′, y′) within the triangle ABC′ of the polygon mesh by using the following steps: 1. Compute three spatial weighting values (a′, b′, c′) according to equirectangular coordinates (x_{A}, Y_{A}, X_{B}, Y_{B}, X_{C}, y_{C}, x, y) by using a barycentric weighting method. 2. compute a face blending weight fw′₁ for a sample point Q′_{F} (corresponding to point Q′) in front-face camera image: fw′₁=a′*w_{1A}+b′*w_{1B}+c′*w_{1C}; compute a face blending weight fw′₂ for a sample point Q′_{T} (corresponding to point Q′) top-face camera image: w′₂=a′*w_{2A}+b′*w_{2B}+c′*w_{2C}; compute a face blending weight fw′₃ for a sample point Q′_{R} (corresponding to point Q′) in right-face camera image: fw′₃=a′*w_{3A}+b′*w_{3B}+c′*w_{3C}. 3. compute texture coordinates for the sample point Q′_{F} (corresponding to point Q′) in front-face camera image: (u1′, v1′)=(a′*u_{1A}+b′*u_{1B}+c′*u_{1C}, a′*v_{1A}+b′*v_{1B}+c′*v_{1C}); compute texture coordinates for the sample point Q′_{T} (corresponding to point Q′) in top-face camera image: (u2′, v2′)=(a′*u_{2A}+b′*u_{2B}+c′*u_{2C}, a′*v_{2A}+b′*v_{2B}+c′*v_{2C}); compute texture coordinates for the sample point Q′_{R} (corresponding to point Q′) right-face camera image: (u3′, v3′)=(a′*u_{3A}+b′*u_{3B}+c′*u_{3C}, a′*v_{3A}+b′*v_{3B}+c′*v_{3C}). Finally, the rasterization engine 61A sends the three texture coordinates (u1′, v1′), (u2′, v2′) and (u3′, v3′) to the three texture mapping engines 621˜623 in parallel, and also sends the three face blending weights (fw′₁, fw′₂, fw′₃) to the blending unit 63. Here, a′+b′+c′=1 and fw′₁+fw′₂+fw′₃=1.

According to the three texture coordinates (u1′, v1′), (u2′, v2′) and (u3′, v3′), the texture mapping engines 621˜623 texture map the texture data of the three-face camera images using any appropriate method (such as nearest-neighbour interpolation, bilinear interpolation or trilinear interpolation) to generate three sample values s1′, s2′ and s3′, and then send the three sample values s1′, s2′ and s3′ to the blending unit 63A. Here, the sample value may be a luma value or/and a chroma value. The blending unit 63A blends the three sample values (s1′, s2′, s3′) together to generate a blended value Vb′ of point Q′. In one embodiment, after receiving the three face blending weights (fw′₁, fw′₂, fw′₃), the blending unit 63A blends the three sample values (s1′, s2′, s3′) together to generate the blended value Vb′ of point Q′ using the following equation: Vb′=w′₁*s1′+w′₂*s2′+w′₃*s3′. Finally, the blending unit 63A stores the blended value Vb′ of point Q′ into the destination buffer 64. In this manner, the blending unit 63A sequentially stores the blended value Vb′ in the destination buffer 64 for each point until all the points within the triangle ABC′ are processed/completed. Likewise, all the points within the triangle ABD′ are processed/completed.

For ease of description, the above same example (four vertices A, B, C′, D′) is used again to describe the operations of the image processing apparatus 100B. In hybrid mode, after determining that none of the four vertices (A, B, C′, D′) has a pole flag equal to 1, the rasterization engine 61B first divides the quadrilateral ABC′D′ into two triangles (e.g., ABC′ and ABD′) and performs triangle rasterization operations for each triangle (ABC′ and ABD′). The rasterization engine 61B sequentially sends the three texture coordinates (u1′, v1′), (u2′, v2′) and (u3′, v3′) to the texture mapping engine 62 and the three face blending weights (fw′₁, fw′₂, fw′₃) to the blending unit 63B, i.e., sending one at a time after computing the three face blending weights (fw′₁, fw′₂, fw′₃) and the three texture coordinates (u1′, v1′), (u2′, v2′) and (u3′, v3′). Then, the texture mapping engine 62 needs to perform the following operations three rounds, i.e., receiving the texture coordinates, texture mapping the texture data of one camera image to generate one sample value, and then sending the sample value to the blending unit 63B. Next, the blending unit 63B also computes and stores three rounds according to the three sample values (s1′, s2′, s3′) and the three face blending weights (fw′₁, fw′₂, fw′₃). Specifically, in the first round, the blending unit 63B receives the sample value s1′ and the face blending weight fw′₁, obtains a first temp value Vt1′ by computing the equation: Vt1′=fw′₁*s1′ and then stores the first temp value Vt1′ in the destination buffer 64. In the second round, the blending unit 63B fetches the first temp value Vt1′ from the destination buffer 64, receives the sample value s2′ and the face blending weight fw′₂, obtains a second temp value Vt2′ by computing the equation: Vt2′=Vt1′+fw′₂*s2′ and then stores the second temp value Vt2′ in the destination buffer 64. In the third round, the blending unit 63B fetches the first temp value Vt2′ from the destination buffer 64, receives the sample value s3′ and the face blending weight fw′₃, obtains the blended value Vb′ by computing the equation: Vb′=Vt2′+fw′₃*s3′ and then stores the blended value Vb′ in the destination buffer 64. In this manner, the blending unit 63B sequentially stores the blended value Vb′ for each point/pixel until all the points within the triangle ABC′ are processed/completed. Likewise, all the points within the triangle ABD′ are processed/completed.

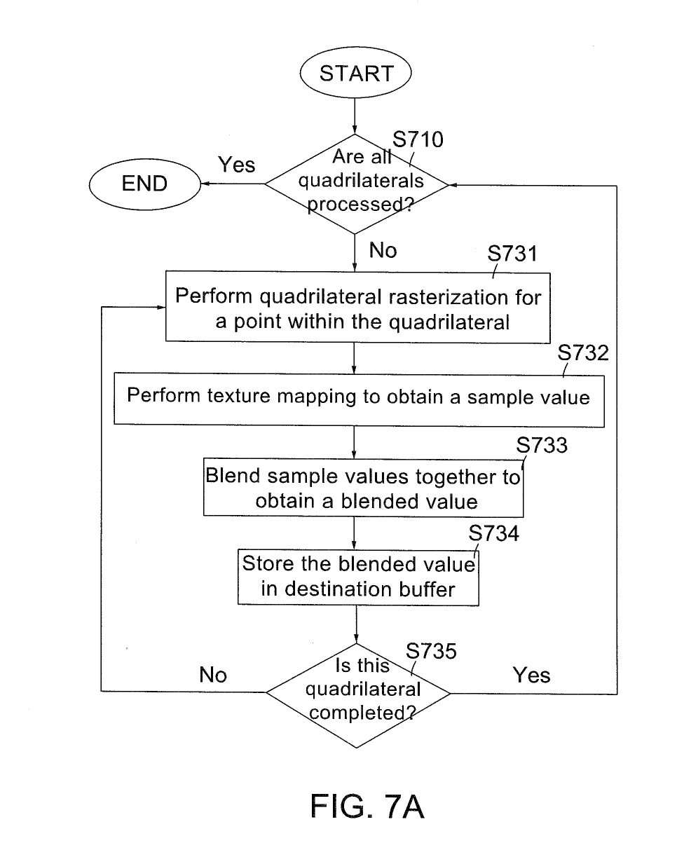

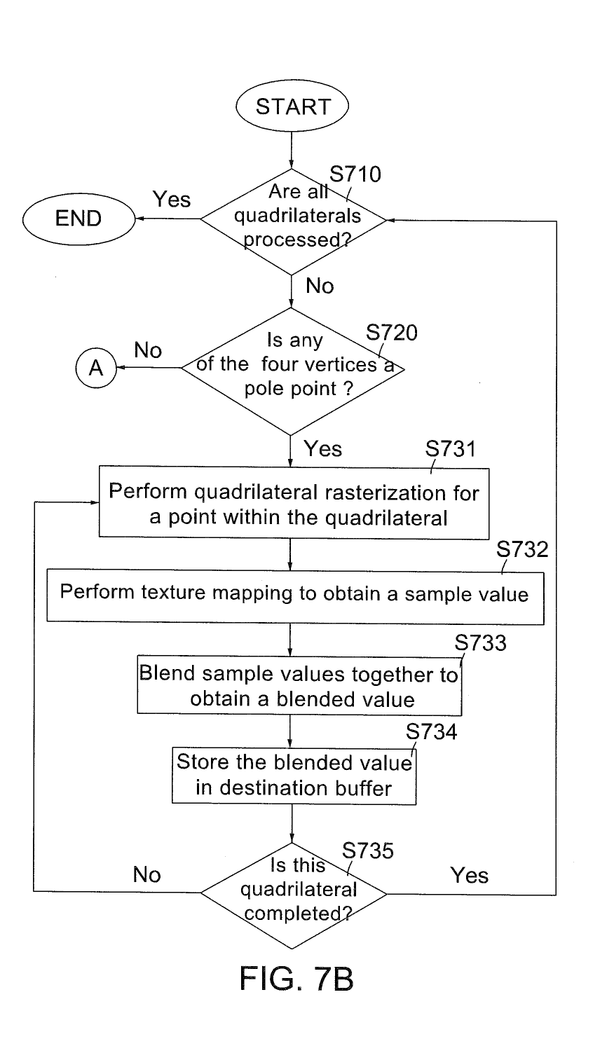

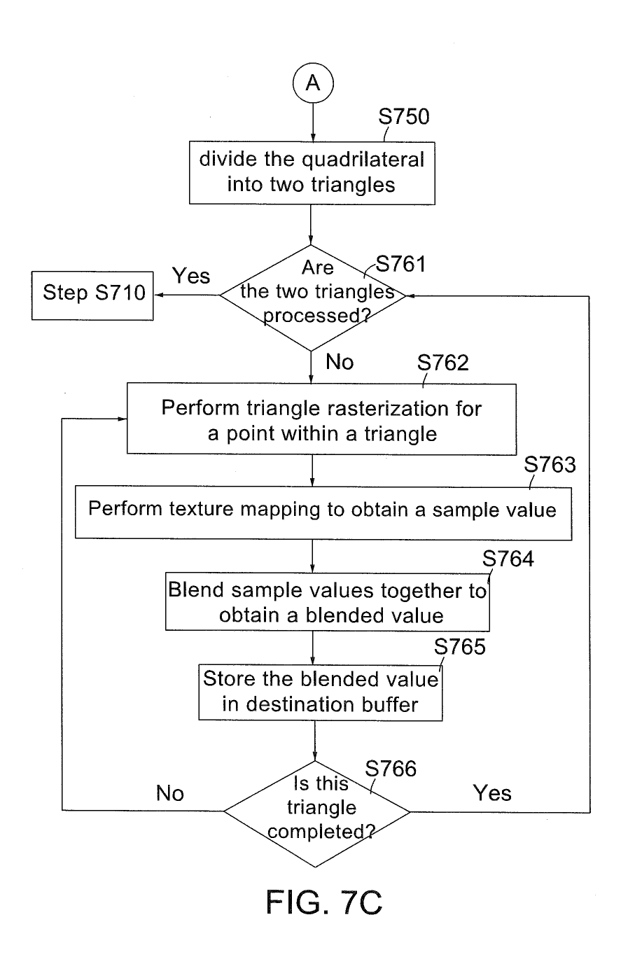

FIG. 7A shows a flow chart of an image processing method according to an embodiment of the invention. Hereinafter, the image processing method of the invention is described with reference to FIGS. 1, 2, 4A-4B, 5A-5B, 6A-6B and 7A. Assuming that the correspondence generator 15 sends the vertex list to the image processing apparatus 100 in advance.

Step S710: Determine whether all the quadrilaterals on the vertex list are processed by the rasterization engine (61A, 61B). According to the vertex list, the rasterization engine (61A, 61B) retrieves a group of vertices forming a polygon from the vertex list at a time until all the polygons are processed/completed. In one embodiment, the rasterization engine (61A, 61B) retrieves four vertices forming a quadrilateral from the vertex list at a time until all the quadrilaterals are processed/completelf all the quadrilaterals are processed, it indicates the default equirectangular panoramic image is completed and the flow is terminated. If not, go to the step S731.

Step S731: Perform quadrilateral rasterization operations for a point within quadrilateral. Referring back to the above example (the point Q having equirectangular coordinates (x, y) within the quadrilateral ABCD), in quadrilateral mode, according to the vertex list, the rasterization engine (61A, 61B) computes texture coordinates and a face blending weight (fw₁, fw₂, fw₃) for each camera image based on the point Q within the quadrilateral ABCD.

Step S732: Perform texture mapping operations to obtain a sample value for each camera image according to the texture coordinates in each camera image. In one embodiment, according to the texture coordinates in each camera image, the texture mapping engine 621˜623 texture maps the texture data of each camera image using any appropriate method (such as nearest-neighbour interpolation, bilinear interpolation or trilinear interpolation) to generate the sample value (s1, s2, s3) for each camera image. Here, the sample value may be a luma value or/and a chroma value.

Step S733: Blend the sample values together to generate a blended value Vb for point Q. In one embodiment, after receiving the face blending weight(s), the blending unit (63A, 63B) blends the sample values (s1, s2, s3) together to generate the blended value Vb of point Q using the following equation: Vb=fw₁*s1+fw₂*s2+fw₃*s3.

Step S734: Store the blended value Vb into the destination buffer 64.

Step S735: Determine whether all the points within the quadrilateral ABCD are processed. If YES, go to the step S710; otherwise, go to the step S731.

FIGS. 7B and 7C show a flow chart of an image processing method according to another embodiment of the invention. Hereinafter, the image processing method of the invention is described with reference to FIGS. 1, 2, 4A-4B, 5A-5B, 6A-6B and 7A-7C. Assuming that the correspondence generator 15 sends the vertex list to the image processing apparatus 100 in advance. In the methods of FIGS. 7A-7C, common reference numerals have been employed where common steps have the same operations. Thus, the description for the common steps is omitted for the sake of brevity.

Step S720: Determine whether any of the four vertices is a pole point. According to the “pole flag” field in the data structure for each of the four vertices in the vertex list, the rasterization engine (61A, 61B) in hybrid mode determines whether any of the four vertices is a pole point. If YES, go to the step S731; otherwise, go to the step S750.

Step S750: Divide the quadrilateral into two triangles. Referring back to the above example (the point Q′ having equirectangular coordinates (x′, y′) within the quadrilateral ABC′D′), the rasterization engine (61A, 61B) in hybrid mode divides the quadrilateral ABC′D′ into two triangles ABC′ and ABD′. Assuming that triangle ABC′ is processed first and then triangle ABD′ is processed.

Step S761: Determine whether the two triangles ABC′ and ABD′ are processed. If YES, go to the step S710; otherwise, go to the step S762.

Step S762: Perform triangle rasterization operations for a point Q′ within triangle ABC′. In one embodiment, according to the vertex list, the rasterization engine (61A, 61B) computes texture coordinates and a face blending weight (fw′₁, fw′₂, fw′₃) for each camera image based on the point Q′ having equirectangular coordinates (x′, y′) within the triangle ABC′.

Step S763: Perform texture mapping operations to obtain a sample value for each camera image according to the texture coordinates in each camera image. In one embodiment, according to the texture coordinates in each camera image, the texture mapping engine 621˜623 texture maps the texture data of each camera image using any appropriate method (such as nearest-neighbour interpolation, bilinear interpolation or trilinear interpolation) to generate the sample value for each camera image. Here, the sample value may be a luma value or/and a chroma value.

Step S764: Blend the sample values together to generate a blended value for point Q′. In one embodiment, after receiving the blending weight(s), the blending unit (63A, 63B) blends the sample values (s1′, s2′, s3′) together to generate the blended value Vb′ of point Q′ using the following equation: Vb′=fw′₁*s1′+fw′₂*s2′+fw′₃*s3′.

Step S765: Store the blended value Vb′ into the destination buffer 64.

Step S766: Determine whether all the points within the triangle (ABC′ or ABD′) are processed. If YES, go to the step S761. If not, go to the step S762.

Please note that the above-mentioned vertex list, surface vertex list, equirectangular coordinates and equirectangular panoramic image are respectively defined as a default vertex list, a default surface vertex list, default equirectangular coordinates and a default equirectangular panoramic image. The default equirectangular coordinates and the default equirectangular panoramic image are respectively different from modified equirectangular coordinates and a modified equirectangular panoramic image (will be described below).

Moreover, due to the fact that the poles regions are highly amplified/stretched to the entire width of the default equirectangular panoramic image, and most people do not look at the pole regions carefully, the pole regions allow to be processed differently to reduce the amount of computation of the default equirectangular panoramic image. The rationale is as follows.

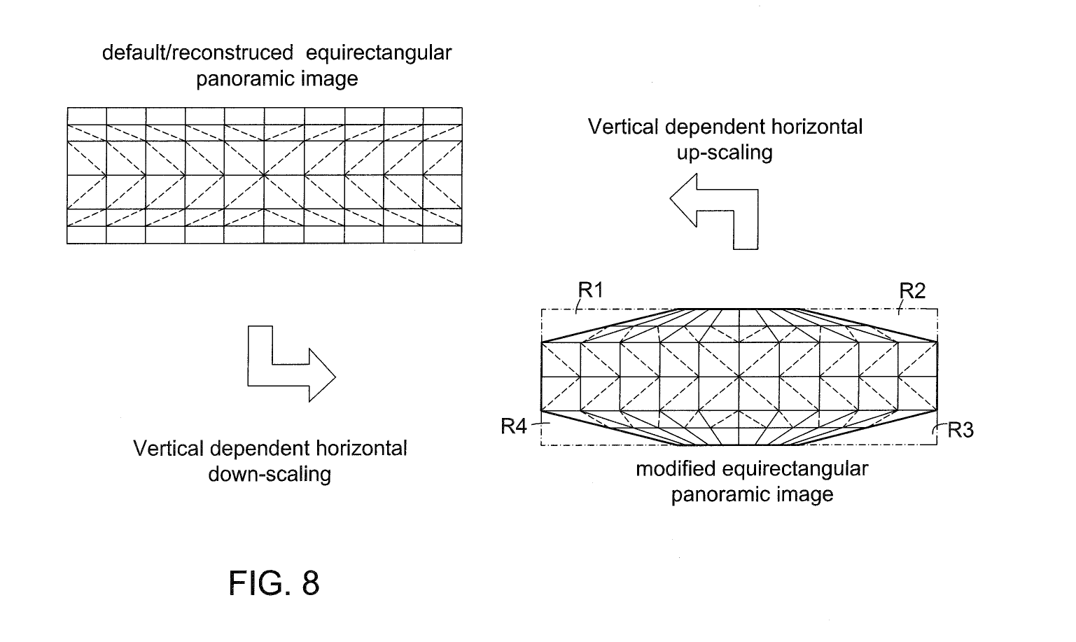

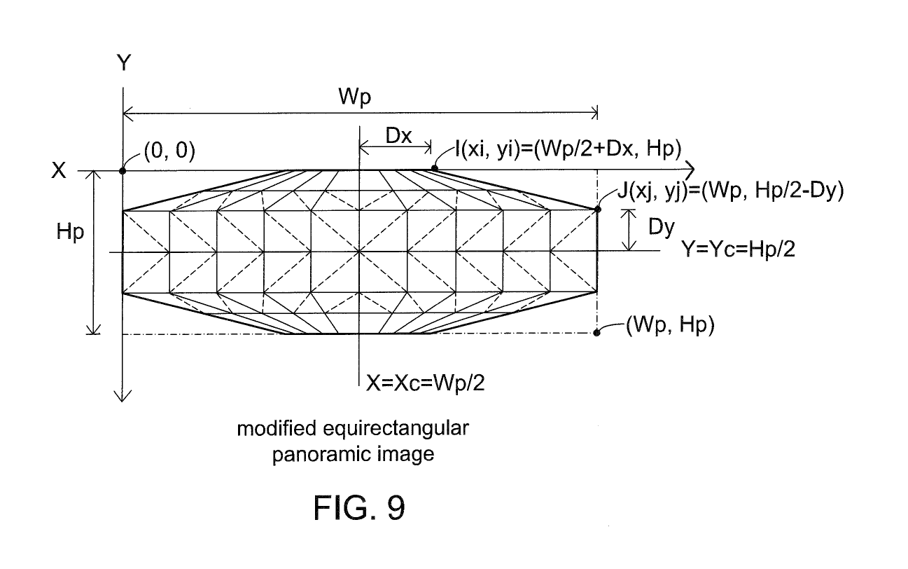

As shown in FIGS. 8 and 9, if X coordinate of each point in the default equirectangular panoramic image on the left side is horizontally down-scaled toward the line X=Xc=Wp/2 according to its Y-coordinate (called “the vertical dependent horizontal down-scaling operations”), a modified equirectangular panoramic image on the right side is obtained. Conversely, if X coordinate of each point in the modified equirectangular panoramic image is horizontally up-scaled relative to the line X=Xc=Wp/2 according to its Y-coordinate (called “the vertical dependent horizontal up-scaling operations”), a reconstructed equirectangular panoramic image is obtained. Theoretically, the reconstructed equirectangular panoramic image is substantially equivalent to the default equirectangular panoramic image. In the example of FIGS. 8 and 9, the modified equirectangular panoramic image is an octagon with four blank regions R1˜R4 while a default/reconstructed equirectangular panoramic image (e.g., FIG. 5B) is a fully-filled rectangular image without any blank regions.

According to the invention, there are two ways to obtain the default/reconstructed equirectangular panoramic image. One of them has been described above (e.g., FIGS. 6A-6B and 7A-7C), and the other one (e.g., FIGS. 6C and 6D) is described below.

FIG. 6C is a schematic diagram showing the image processing apparatus according to another embodiment of the invention. FIG. 6D is a schematic diagram showing the image processing apparatus according to another embodiment of the invention. Compared to FIGS. 6A-6B, a up-scaling unit 65 and an image buffer 66 are additionally included.

In one embodiment, in the offline phase, the correspondence generator 15 firstly adopts appropriate image registration techniques to generate a modified vertex list (or modified surface vertex lists), and the data structure of each vertex in the modified vertex list provides the mapping relationship between the modified equirectangular panoramic image and camera images (or between the modified equirectangular coordinates (or space) and the texture coordinates (or space)). Next, referring to FIGS. 6C and 6D, since the rasterization engines (61A, 61B) receives the modified vertex list, the destination buffer 64 stores the modified equirectangular panoramic image rather than the default equirectangular panoramic image. Then, the up-scaling unit 65 generates a reconstructed equirectangular panoramic image by sequentially re-sampling the modifified equirectanglar panoramic image on a line-by-line base through the above vertical dependent horizontal up-scaling operations. In this way, the reconstructed equirectangular panoramic image is formed and stored in the image buffer 66. Referring again to FIG. 8, since there is no need to render image data in the four blank regions R1˜R4 of the modified equirectangular panoramic image, the amount of computations for the rasterization engine (61A, 61B), the texture mapping engine (62, 621˜2P) and the blending unit (63A, 63B) are significantly reduced in FIGS. 6C-6D. Even though there is a up-scaling unit 65 additionally included in the image processing apparatus (100C, 100D), the amount of computations for the up-scaling unit 65 is much less than those for the rasterization engine (61A, 61B), the texture mapping engine (62, 621˜2P) and the blending unit (63A, 63B). Compare to FIGS. 6A-6B, a large reduction in the computation amount is achieved in FIGS. 6C-6D.

Hereinafter, the related functions and parameters for the vertical dependent horizontal up-scaling and down-scaling operations are described with reference to FIGS. 8-9.

Let a point T has default equirectangular coordinates (Xt, Yt). If the point T is transformed into the modified equirectangular domain, it becomes a point T′ with modified equirectangular coordinates (Xt′, Yt′). In this case, Yt′=Yt and Xt′=Downscaling(W′, Wp, Xt). In one embodiment, the above down-scaling function/transform is performed over each vertex in the modified vertex list to get its own new coordinate in modified equirectangular domain. Contrarily, if the point T′ with modified equirectangular coordinates (Xt′, Yt′) is transformed back into the default/reconstructed equirectangular domain, it backs to the point T with default/reconstructed equirectangular coordinates (Xt, Yt). In this case, Yt=Yt′ and Xt=Upscaling(Wp, W′, Xt′). However, when the modified equirectangular panoramic image is transformed to the reconstructed equirectangular panoramic image, it means that each pixel data in the reconstructed equirectangular panoramic image is obtained by resampling its corresponding pixel line of the modified equirectangular panoramic image, and the x-coordinate Xt′ is calculated through the function DownScaling(W′, Wp, Xt). Here, the function Downscaling(W′, Wp, Xt) is given by: Xt′=Wp/2+(Xt−Wp/2)*W′/Wp; the function Upscaling(Wp, W′, Xt) is given by: Xt=Wp/2+(Xt′−Wp/2)*Wp/W′. Please note that (Xt−Wp/2)/W′=(Xt−Wp/2)/Wp. W′ is defined by a function f1, which is given by: W′=f1(Yt, Wp, Hp, Dx, Dy). Referring to FIG. 9, Wp and Hp are the width and the height of the default/modified equirectangular panoramic image, respectively; Dx is a half of the width of the top/bottom side of the octagon and Dy is a half of the height of the rightmost/leftmost side of the octagon; a point I is a rightmost point at the top side of the octagon; a point J is a topmost point at the rightmost side of the octagon. In one embodiment, the following program codes are provided in function f1(Yt, Wp, Hp, Dx, Dy) to calculate W′.

```
    m1 = (Wp−2*Dx)/(Hp/2−Dy−0) = (Wp−2*Dx)/(Hp/2−Dy); //for
upper part
    m2 =(Wp−2*Dx)/(Hp/2+Dy−Hp); //for lower part
    If (Yt<Hp/2−Dy) {
        W′ = (Yt−0)*m1 + 2*Dx = m1*Yt + 2*Dx;
      }
    Else if (Yt>Hp/2+Dy) {
          W′ = (Yt−Hp)*m2 + 2*Dx = m2*(Yt−Hp) + 2*Dx;
      }
    Else {
          W′ = Wp;
      }
```

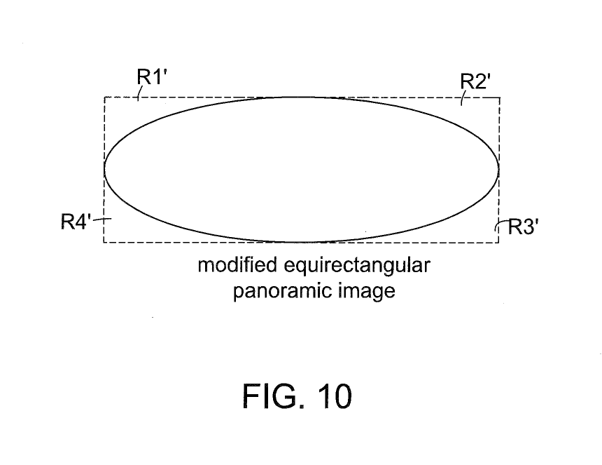

In the example of FIGS. 8 and 9, the modified equirectangular panoramic image is an octagon defined by four segments Dx, Dy, Wp and Hp. In a case that Dx=0, the modified equirectangular panoramic image becomes a hexagon. However, the above shapes of the modified equirectangular panoramic image are only utilized as embodiments and not limitations. In the actual implements, any other shapes can be used and this also falls in the scope of the invention. For an example, the modified equirectangular panoramic image forms a shape of a polygon with at least one blank region, and each side of the polygon is defined by a piecewise linear function. For another example, the modified equirectangular panoramic image forms a shape of a closed curve having at least one blank region and defined by a look-up table, such as forming a shape of an ellipse with four blank regions R1′˜R4′ as shown in FIG. 10.

In a case that the overlapping regions 30-32 does not exist in the equirectangular panoramic image of FIG. 3 (i.e., each pixel/point of the equirectangular panoramic image coming from a single camera image), there would be no need to perform blending operations. In that case, the blending unit 63B may be excluded from the image processing apparatus 100B/100D. In the meantime, since each pixel/point of the equirectangular panoramic image comes from a single camera image, the rasterization engine 61B simply sends its texture coordinates of its corresponding camera image to the texture mapping engine 62, and the texture mapping engine 62 receives the texture coordinates, texture maps the texture data from its corresponding camera image to generate one sample value, and then sends the sample value to the destination buffer 64. Since the blending unit 63B is optional, it is represented by dash lines in FIGS. 6B and 6D.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. An image processing apparatus for receiving a plurality of camera images and generating a panoramic image, comprising:
a rasterization engine for receiving a group of vertices from a vertex list and performing polygon rasterization operations for a point within the group of vertices forming a polygon to generate texture coordinates for each camera image, wherein the vertex list comprises a plurality of vertices with their data structures;
a texture mapping module for generating a sample value for each camera image corresponding to the point by texture mapping texture data from each camera image according to its texture coordinates; and
a destination buffer coupled to the texture mapping module for storing the panoramic image;
wherein the data structures define a vertex mapping between the panoramic image and the camera images.

2. The apparatus according to claim 1, wherein the panoramic image is a 360 degree panoramic image, and wherein the rasterization engine receives four vertices from the vertex list and performs polygon rasterization operations for the point within the four vertices forming a quadrilateral to generate the texture coordinates for each camera image.

3. The apparatus according to claim 1, wherein the panoramic image is a default equirectangular panoramic image and the data structures further define a vertex mapping between the default equirectangular panoramic image and the camera images, and wherein the default equirectangular panoramic image is a fully-filled rectangular image without any blank regions.

4. The apparatus according to claim 2, wherein the polygon rasterization operations are quadrilateral rasterization operations and the quadrilateral is located in the top row or the bottom row of a polygon mesh modeling the 360 degree panoramic image.

5. The apparatus according to claim 2, wherein in quadrilateral mode, the rasterization engine performs quadrilateral rasterization operations for the point within the quadrilateral to generate the texture coordinates for each camera image.

6. The apparatus according to claim 2, wherein the rasterization engine further determines whether to divide the quadrilateral into two triangles according to either the data structures or destination coordinates of the four vertices, and wherein each data structure indicates whether its vertex is a pole point.

7. The apparatus according to claim 6, wherein when any of the four vertices is a pole point, the rasterization engine performs quadrilateral rasterization operations for the point within the quadrilateral, otherwise performs triangle rasterization operations for the point within any of the two triangles.

8. The apparatus according to claim 1, wherein the texture mapping module comprises P texture mapping engines that operate in parallel, wherein each texture mapping engine texture maps texture data from one camera image according to its texture coordinates to generate the sample value for the camera image, and wherein the rasterization engine supplies the texture coordinates for the camera images to the P texture mapping engines in parallel.

9. The apparatus according to claim 8, further comprising:
a blending unit coupled between the texture mapping module and the destination buffer for blending the sample value for each camera image at a time to store a blended value in the destination buffer.

10. The apparatus according to claim 1, wherein the texture mapping module sequentially texture maps texture data from each camera image according to its sequentially-received texture coordinates to generate the sample value for the camera image.

11. The apparatus according to claim 10, further comprising:
a blending unit coupled between the texture mapping module and the destination buffer for sequentially blending the sample value for each camera image to generate the blended value.

12. The apparatus according to claim 1, further comprising:
a blending unit coupled between the texture mapping module and the destination buffer for blends the sample value for each camera image according to a corresponding face blending weight to generate the blended value;
wherein the rasterization engine further generates the corresponding face blending weight for each camera image according to the data structures of the four vertices and destination coordinates of the point.

13. The apparatus according to claim 1, further comprising:
an up-scaling unit for generating a reconstructed equirectangular panoramic image by sequentially re-sampling a modified equirectanglar panoramic image from the destination buffer on a line-by-line base;
wherein the data structures further define a vertex mapping between the modified equirectangular panoramic image and the camera images,
wherein the modified equirectangular panoramic image forms a shape of a polygon or a closed curve with at least one blank region, and wherein the reconstructed equirectangular panoramic image is a fully-filled rectangular image without any blank regions.

14. The apparatus according to claim 1, further comprising:
a blending unit coupled between the texture mapping module and the destination buffer for sequentially blending the sample value for a corresponding camera image to generate the blended value;
wherein the vertex list is divided into a plurality of surface vertex lists and a number of surface vertex lists is equal to a number of camera images, wherein the rasterization engine receives one surface vertex list at a time, and wherein the texture mapping module sequentially texture maps texture data from the corresponding camera image according to its sequentially-received texture coordinates to generate the sample value for the corresponding camera image.

15. An image processing method applied in an image processing apparatus, the method comprising:
receiving a group of vertices from a vertex list;
performing polygon rasterization operations for a point within the group of vertices forming a polygon to obtain texture coordinates for each of a plurality of camera images, wherein the vertex list comprises a plurality of vertices with their data structures;
texture mapping texture data from each camera image according to its texture coordinates to obtain a sample value for each camera image corresponding to the point; and
repeating the above steps until all the points within the polygon are processed;
wherein the data structures define a vertex mapping between a panoramic image and the camera images.

16. The method according to claim 15, further comprising:
storing the sample value for each camera image corresponding to the point in a destination buffer after the step of texture mapping and before the step of repeating;
repeating the above steps until all the points within all the polygons from the vertex list are processed; and
outputting a contain of the destination buffer as the panoramic image.

17. The method according to claim 16, further comprising:
repeating the above steps until all surface vertex lists are processed before the step of outputting;
wherein the step of receiving further comprises:
receiving the group of vertices from one surface vertex list of the vertex list, wherein the vertex list is divided into a plurality of surface vertex lists and a number of surface vertex lists is equal to a number of camera images.

18. The method according to claim 15, wherein the step of performing the polygon rasterization operations further comprises:
receiving four vertices from the vertex list; and
performing the polygon rasterization operations for the point within the four vertices forming a quadrilateral to generate the texture coordinates for each camera image;
wherein the panoramic image is a 360 degree panoramic image.

19. The method according to claim 18, wherein the polygon rasterization operations are quadrilateral rasterization operations and the quadrilateral is located in the top row or the bottom row of a polygon mesh modeling the panoramic image.

20. The method according to claim 18, wherein the step of performing the polygon rasterization operations further comprises:
performing quadrilateral rasterization operations for the point within the quadrilateral to generate the texture coordinates for each camera image.

21. The method according to claim 18, wherein the step of performing the polygon rasterization operations further comprises:
determining whether to divide the quadrilateral into two triangles according to either the data structures or destination coordinates of the four vertices;
wherein each data structure indicates whether its vertex is a pole point.

22. The method according to claim 21, wherein the step of performing the polygon rasterization operations further comprises:
when any of the four vertices is a pole point, performing quadrilateral rasterization operations for the point within the quadrilateral, otherwise performing triangle rasterization operations for the point within any of the two triangles.

23. The method according to claim 15, wherein the step of texture mapping further comprises:
receiving the texture coordinates for the camera images in parallel;
texture mapping the texture data from the camera images according to their texture coordinates to generate the sample value for each camera image in parallel.

24. The method according to claim 23, further comprising:
blending the sample value for each camera image at a time to generate a blended value; and
storing the blended value in a destination buffer.

25. The method according to claim 15, wherein the step of texture mapping further comprises:
sequentially texture mapping texture data from each camera image according to its sequentially-received texture coordinates for each camera image to generate the sample value for each camera image.

26. The method according to claim 25, further comprising:
sequentially blends the sample value for each camera image to generate a blended value; and
storing the blended value in a destination buffer.

27. The method according to claim 15, further comprising:
obtaining a face blending weight for each camera image according to the data structures of the four vertices and destination coordinates of the point;
blending the sample value for each camera image according to its face blending weight to generate a blended value; and
storing the blended value in a destination buffer.

28. The method according to claim 16, further comprising:
sequentially re-sampling a modified equirectanglar panoramic image from the destination buffer on a line-by-line base to obtain a reconstructed equirectangular panoramic image;
wherein the data structures further define a vertex mapping between the modified equirectangular panoramic image and the camera images,
wherein the modified equirectangular panoramic image forms a shape of a polygon or a closed curve with at least one blank region, and wherein the reconstructed equirectangular panoramic image is a fully-filled rectangular image without any blank regions.

29. The method according to claim 15, wherein the panoramic image is a default equirectangular panoramic image and the data structures further define a vertex mapping between the default equirectangular panoramic image and the camera images, and wherein the default equirectangular panoramic image is a fully-filled rectangular image without any blank regions.
